(19) United States
(12) Patent Application Publication
(10) Pub. No.: US 2025/0231357 A1
(43) Pub. Date: Jul. 17, 2025

(54) Data Communication Device

(71) Applicant: Marvell Asia Pte Ltd, Singapore (SG)

(72) Inventors: Pushkraj Tumne, Agoura Hill, CA (US); Roberto Coccioli, Simi Valley, CA (US); Dwayne R. Shirley, Valley Glen, CA (US); Hsiu-Che Wang, Oak Park, CA (US)

(21) Appl. No.: 19/014,277

(22) Filed: Jan. 9, 2025

Related U.S. Application Data
(60) Provisional application No. 63/620,082, filed on Jan. 11, 2024.

(51) Int. Cl. G02B 6/42; G02B 6/12

(52) U.S. Cl. CPC G02B 6/425; G02B 6/12; G02B 6/424

(57) ABSTRACT

A communication device, consisting of at least one semiconducting die and an electronic integrated circuit (EIC) formed on a first side of the at least one die. The device also has at least one first array of micro-light emitting diodes (micro-LEDs), mounted on a second side of the at least one die that is opposite the first side. The micro-LEDs are electrically connected to the EIC and are configured to transmit outbound optical signals to respective first optical fibers. The device also has at least one second array of photo-diodes, mounted on the second side of the at least one die. The photo-diodes are electrically connected to the EIC and are configured to receive inbound optical signals from respective second optical fibers.

### CROSS-REFERENCE TO RELATED APPLICATION

This application claims the benefit of U.S. Provisional Patent Application 63/620,082, filed Jan. 11, 2024, which is incorporated herein by reference.

### FIELD OF THE DISCLOSURE

This disclosure relates generally to data communication, and specifically to data communication between integrated circuits.

### BACKGROUND

In order for a facility such as a data center to operate efficiently, the extremely large amounts of data used by integrated circuits (ICs) of the center need to transfer quickly between the ICs. Fast data transfer within data centers is typically implemented through a combination of high-speed networking equipment, such as switches and routers that support large bandwidths like 10 Gbps, 40 Gbps, 100 Gbps, and 400 Gbps, or even higher.

### SUMMARY

An embodiment of the present disclosure provides a communication device, including:
at least one semiconducting die;
an electronic integrated circuit (EIC) formed on a first side of the at least one die;
at least one first array of micro-light emitting diodes (micro-LEDs), mounted on a second side of the at least one die that is opposite the first side, the micro-LEDs being electrically connected to the EIC and configured to transmit outbound optical signals to respective first optical fibers; and
at least one second array of photo-diodes, mounted on the second side of the at least one die, the photo-diodes being electrically connected to the EIC and configured to receive inbound optical signals from respective second optical fibers.

In a disclosed embodiment the communication device further includes:
an optical element, retained in a housing, configured to couple the first optical fibers to the at least one first array of micro-LEDs, and to couple the second optical fibers to the at least one second array of photo-diodes; and
at least one channel formed in the second side of the at least one die;
wherein a section of the housing is configured to fit into the at least one channel and thereby align the optical element with the at least one first array of micro-LEDs and the at least one second array of photo-diodes.

The at least one channel may be formed at a pre-designed distance from the at least one first array of micro-LEDs and the at least one second array of photo-diodes.

In a further discloses embodiment the at least one first array of micro-LEDs includes n first arrays, and the at least one second array of photo-diodes includes n second arrays, wherein n is a positive integer, wherein the first optical fibers include n first optical fiber bundles that align with the n first arrays, and wherein the second optical fibers include n second optical fiber bundles that align with the n second arrays.

In a yet further disclosed embodiment The communication device includes conductive channels formed in the at least one die, and the EIC, the at least one first array of micro-LEDs, and the at least one second array of photo-diodes are connected to the conductive channels and are configured to communicate therebetween via the conductive channels.

A quantity of micro-LEDs defining the at least one first array of micro-LEDs may be equal to the quantity of photo-diodes defining the least one second array of photo-diodes.

The EIC may be configured to convert outgoing data from the EIC from a parallel format to a serial format, and to provide the outgoing data in the serial format to micro-LEDs in the at least one first array of micro-LEDs.

The EIC may be configured to receive incoming data to the EIC in a serial format from photo-diodes in the at least one second array of photo-diodes, and convert the incoming data from the serial format to a parallel format.

The at least one semiconducting die may be a single die. Alternatively, the at least one semiconducting die includes a stack of dies.

In an alternative embodiment the communication device includes:
an optical element, retained in a housing, configured to couple the first optical fibers to the at least one first array of micro-LEDs, and to couple the second optical fibers to the at least one second array of photo-diodes; and
a protrusion formed in the second side of the at least one die;
wherein a section of the housing includes a channel formed therein and that is configured to fit into the protrusion and thereby align the optical element with the at least one first array of micro-LEDs and the at least one second array of photo-diodes, and wherein the protrusion and the channel are formed by etching.

There is further provided, according to an embodiment of the present disclosure, a method for aligning optical elements, including:
mounting a first optical element on a surface of a semiconducting die;
forming at least one channel in the surface of the die in proximity to the first optical element;
mounting a second optical element in a housing; and
configuring a section of the housing to fit into the at least one channel, so that when the section of the housing is fit into the at least one channel the first optical element aligns optically with the second optical element.

In a disclosed embodiment the first optical element includes at least one first array of micro-light emitting diodes (micro-LEDs) and at least one second array of photo-diodes, and the second optical element includes first optical fibers configured to couple with the at least one first array of micro-LEDs and second optical fibers configured to couple with the at least one second array of photo-diodes.

The method may include forming the at least one channel at a pre-designed distance from the at least one first array of micro-LEDs and the at least one second array of photo-diodes.

In a further disclosed embodiment the at least one first array of micro-LEDs includes n first arrays, and the at least one second array of photo-diodes includes n second arrays, wherein n is a positive integer, and wherein the first optical fibers include n first optical fiber bundles that align with the n first arrays, and wherein the second optical fibers include n second optical fiber bundles that align with the n second arrays.

There is further provided, according to an embodiment of the present disclosure, a communication device, including:
an interposer, having a plurality of conductive channels;
an electronic integrated circuit (EIC), formed on at least one die, coupled to the conductive channels;
at least one first array of micro-light emitting diodes (micro-LEDs) mounted on the interposer, the at least one first array of micro-LEDs being coupled to the conductive channels and configured to receive data from the EIC via the conductive channels; and
at least one second array of photo-diodes mounted on the interposer, the at least one second array of photo-diodes being coupled to the conductive channels and configured to transfer data to the EIC via the conductive channels.

The interposer may have a first side and a second side opposite the first side, wherein the at least one die and the at least one first array of micro-LEDs and the at least one second array of photo-diodes are mounted on the first side. There may be a plurality of surface mounted terminals mounted on the second side, the surface mounted terminals being connected to the conductive channels and configured to transfer signals between the surface mounted terminals and the at least one first array of micro-LEDs, the at least one second array of photo-diodes, and the EIC.

In a disclosed embodiment the at least one first array of micro-LEDs is configured to transmit outbound optical signals to first optical fibers and the at least one second array of photo-diodes is configured to receive inbound optical signals from second optical fibers.

In a further disclosed embodiment the communication device includes:
an optical element, retained in a housing, configured to couple the first optical fibers to the at least one first array of micro-LEDs, and to couple the second optical fibers to the at least one second array of photo-diodes; and
at least one channel formed in a side of the interposer;
wherein a section of the housing is configured to fit into the at least one channel and thereby align the optical element with the at least one first array of micro-LEDs and the at least one second array of photo-diodes.

The at least one channel may be formed at a pre-designed distance from the at least one first array of micro-LEDs and the at least one second array of photo-diodes.

In a yet further disclosed embodiment, the at least one first array of micro-LEDs includes n first arrays, and the at least one second array of photo-diodes includes n second arrays, wherein n is a positive integer, and wherein the first optical fibers include n first optical fiber bundles that align with the n first arrays, and wherein the second optical fibers include n second optical fiber bundles that align with the n second arrays.

There is further provided, according to an embodiment of the present disclosure, a method for communicating, including:
providing at least one semiconducting die;
forming an electronic integrated circuit (EIC) on a first side of the at least one die;
mounting at least one first array of micro-light emitting diodes (micro-LEDs) on a second side of the at least one die that is opposite the first side, the micro-LEDs being electrically connected to the EIC and configured to transmit outbound optical signals to respective first optical fibers; and
mounting at least one second array of photo-diodes on the second side of the at least one die, the photo-diodes being electrically connected to the EIC and configured to receive inbound optical signals from respective second optical fibers.

There is further provided, according to an embodiment of the present disclosure, apparatus for aligning optical elements, including:
a semiconducting die;
a first optical element mounted on a surface of the semiconducting die;
at least one channel, formed in the surface of the die in proximity to the first optical element; and
a second optical element mounted in a housing,
wherein a section of the housing is configured to fit into the at least one channel, so that when the section of the housing is fit into the at least one channel the first optical element aligns optically with the second optical element.

There is further provided, according to an embodiment of the present disclosure, a method for communicating, including:
providing an interposer having a plurality of conductive channels;
forming an electronic integrated circuit (EIC) on at least one die, and coupling the EIC to the conductive channels;
mounting at least one first array of micro-light emitting diodes (micro-LEDs) on the interposer, the at least one first array of micro-LEDs being coupled to the conductive channels and configured to receive data from the EIC via the conductive channels; and
mounting at least one second array of photo-diodes on the interposer, the at least one second array of photo-diodes being coupled to the conductive channels and configured to transfer data to the EIC via the conductive channels.

The present disclosure will be more fully understood from the following detailed description of the embodiments thereof, taken together with the drawings, in which:

### BRIEF DESCRIPTION OF THE DRAWINGS

FIG. 1 is a schematic illustration of elements of a data center facility, according to an embodiment described herein;

FIG. 2 is a schematic drawing of a side-view and of a top-down view of a communication device, according to an embodiment described herein;

FIG. 3 is a schematic drawing of a side-view and a top-down view of an alternative communication device, according to an embodiment described herein;

FIG. 4 is a flowchart of steps for forming a communication device, according to an embodiment described herein;

FIG. 5 is a schematic diagram illustrating a method for coupling an optical fiber cable pair to a communication device, according to an embodiment described herein;

FIG. 6 is a flowchart of steps for coupling two optical elements so that they align, according to an embodiment described herein;

FIG. 7 is a schematic drawing of a side-view of a further alternative communication device, according to an embodiment described herein;

FIG. 8 is a flowchart of steps for producing a communication device using an interposer, according to an embodiment described herein; and

FIG. 9 is a schematic block diagram illustrating the data flow through a communication device, according to an embodiment described herein.

### DETAILED DESCRIPTION OF EMBODIMENTS

### Overview

Within entities such as data center facilities and artificial intelligence systems, extremely large quantities of data need to be transferred at a fast rate, typically between application specific integrated circuits (ASICs) of the entities. The data transfer rate required is typically of the order of 100 Gbps or more, but providing high bandwidth channels capable of handling such high rates is difficult. Such high bandwidth channels, for example, couple a photonic integrated circuit (PIC) to the ASIC using wirebonding or face-to-face assembly. However, both wirebonding and face-to-face assembly are problematic, the former having limitations on interconnect density, the latter requiring wirebonding or cutting of a hole in the substrate of the ASIC to allow light to couple to the photonic integrated circuit.

Embodiments of the present disclosure transfer the large amounts of data for an ASIC using a communication device, coupled to the ASIC, which incorporates the data into a plurality of low bandwidth channels. Incoming data to the device is received by an array of photo-diodes, each photo-diode of the array being coupled to a respective optical fiber, in a bundle of optical fibers, optically conveying the incoming data. The incoming data from the photo-diodes is then transferred to the ASIC.

Outgoing data from the ASIC is conveyed to an array of micro-light emitting diodes (micro-LEDs) in the communication device. Each micro-LED of the array is coupled to a respective optical fiber, in another bundle of optical fibers, optically conveying the outgoing data.

While each fiber in an optical fiber bundle operates as a low bandwidth channel, the combined bundles provide the incoming and outgoing high bandwidth required.

In an embodiment described hereinbelow, the ASIC is formed on a first, active side of a die, or stack of dies. The micro-LED and photo-diode arrays are mounted on a second side of the die or stack of dies. The arrays act as photonic integrated circuits, and the mounting of the arrays serves to separate the electronic and photonic integrated circuits and does not require wirebonding. In addition, mounting the arrays, as described herein, on the die of the ASIC makes the overall system more compact, reduces the footprint of the overall system, and reduces the overall power consumption.

In an alternative embodiment the die retaining the ASIC is mounted on the surface of a semiconducting interposer, and the photo-diode and micro-LED arrays are also mounted on the interposer. The ASIC and arrays are connected to each other by conductive channels in the interposer. The arrangement serves to separate the electronic and photonic integrated circuits.

In a disclosed embodiment, terminations of the bundles of optical fibers coupled to the arrays are fixedly held in an optical fiber housing connector. Alignment channels for the connector are etched into the surface of the die, in proximity to the photo-diode and micro-LED arrays. The connector is provided with a mechanical support structure that mates with the alignment channels so that each photo-diode array aligns with the terminations of its bundle of optical fibers, and so that each micro-LED array aligns with the terminations of its bundle of optical fibers. Using alignment channels etched in the ASIC die enables precise, passive, alignment of the optical fiber terminations with each of the photo-diodes and micro-LEDs in their arrays, thus avoiding the need for active optical alignment.

### Detailed Description

In the following description, like elements in the drawings are identified by like numerals and are differentiated as necessary by appending a letter. In addition, all directional references (e.g., upper, lower, upward, downward, left, right, top, bottom, above, below, vertical, and horizontal) are only used for identification purposes to aid the reader's understanding of the present disclosure, and do not create limitations, particularly as to the position, orientation, or use of embodiments of the disclosure.

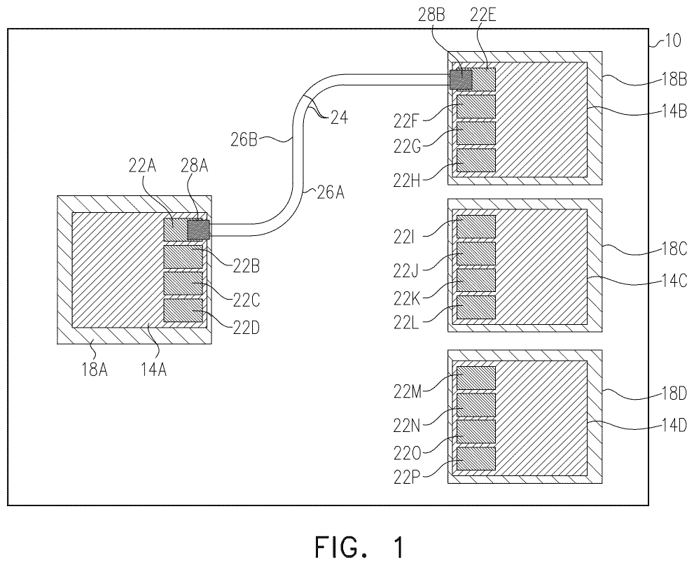

Reference is now made to FIG. 1, which is a schematic illustration of elements of a data center facility 10, according to an embodiment described herein. Facility 10 comprises a multiplicity of generally similar electronic integrated circuits (EICs) 14A, 14B, 14C, and 14D, also referred to herein as ICs 14A, 14B, 14C, and 14D. ICs 14A, 14B, 14C, and 14D are each mounted on a respective IC substrate 18A, 18B, 18C, 18D. ICs 14A, 14B, . . . and IC substrates 18A, 18B, . . . are referred to generically herein as ICs 14 and IC substrates 18. As necessary, a similar convention is used for other elements described herein. In some embodiments a given IC 14 may comprise a graphic processing unit or a computer processing unit.

In order for ICs 14 to communicate with each other, one or more generally similar communication devices are coupled to each IC. By way of example, in the illustration IC 14A has four communication devices 22A, 22B, 22C, and 22D, IC 14B has four communication devices 22E, 22F, 22G, and 22H, IC 14C has four communication devices 22I, 22J, 22K, and 22L, and IC 14D has four communication devices 22M, 22N, 22O, and 22P. Communication devices 22A, 22B, . . . are generically referred to herein as communication devices 22. Each device 22 uses its respective IC and is herein assumed to comprise its respective IC.

Each device 22 receives outgoing data from its IC and transmits the outgoing data in a first optical fiber cable connected to the device. In addition, each device 22 receives incoming data for its IC in a second optical fiber cable connected to the device and conveys the incoming data to its IC. As is described below, each optical fiber cable may have one or more optical fiber bundles, each bundle comprising a plurality of optical fibers. The first and second optical fiber cables operate together and are herein termed a cable pair.

While each device 22 is thus connected to a cable pair 24, for simplicity, in FIG. 1 only one cable pair is illustrated, namely cable pair 24 coupling communication device 22A to communication device 22E. Cable pair 24 has two cable endings, a first cable ending 28A and a second cable ending 28B, and the connection between devices 22A and 22E is implemented by coupling cable ending 28A to device 22A and coupling cable ending 28B to device 22E.

Cable pair 24 comprises a first optical fiber cable 26A and a second optical fiber cable 26B. Optical fiber cable 26A conveys transmitted outgoing data from device 22A to device 22E, where it is incoming data. Optical fiber cable 26B conveys transmitted outgoing data from device 22E to device 22A, where it is incoming data.

The structure and functionality of communication device 22A, as well as its connection to cable pair 24, are described in more detail below.

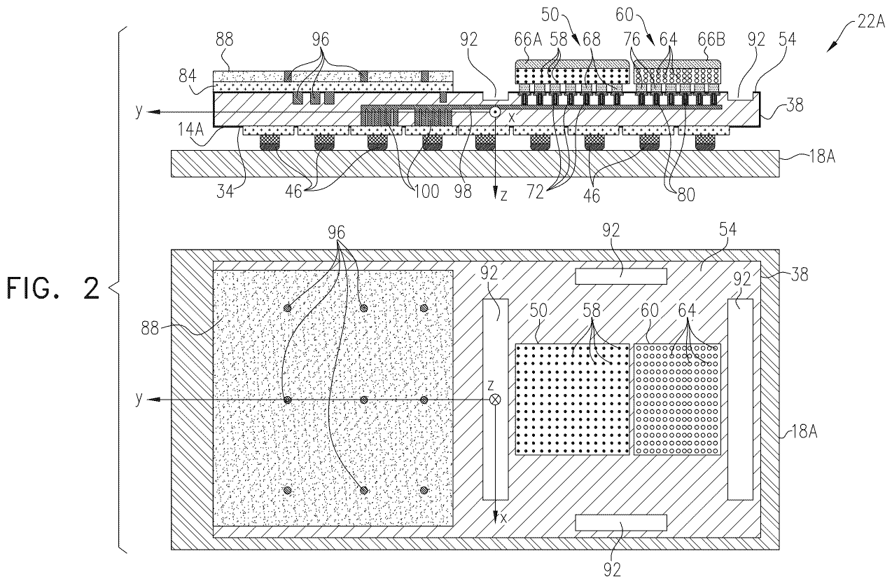

FIG. 2 is a schematic drawing of a side-view and of a top-down view of communication device 22A, according to an embodiment described herein. As described above, device 22A comprises integrated circuit (IC) 14A. IC 14A is herein by way of example assumed to comprise an application specific integrated circuit (ASIC), and is also referred to as ASIC 14A. ASIC 14A is formed on a first, active, side 34 of a semiconducting die 38.

In some embodiments die 38 is a single die; in other embodiments die 38 is one of a stack of dies. In the disclosure, for clarity and simplicity, die 38 is assumed to be a single die having a second side 54 opposite first, active, side 34, i.e., the side comprising ASIC 14A. Those having ordinary skill in the art will be able to adapt the description, mutatis mutandis, for the case that die 38 is one of a stack of dies, wherein the stack has a second side corresponding to second side 54.

Device 22A is mounted on substrate 18A, herein by way of example assumed to be rectangular, and is coupled to the substrate by suitable surface mounted terminals 46. For clarity, device 22A has been drawn on a set of orthogonal xyz axes. The axes are parallel to the edges of substrate 18A, with an origin at a center of die 38, and the z-axis is normal to the substrate.

An array of micro-light emitting diodes, (micro-LED) array 50, is fixedly mounted on second side 54 of die 38. Side 54 is also termed herein back side 54. Micro-LED array 50 comprises a plurality of micro-LEDs 58 and the micro-LEDS are used to transmit data from device 22A, as is described below. A lens cap 66A, comprising a plurality of micro-lenses aligned with micro-LEDs 58, covers array 50. In a disclosed embodiment all micro-LEDs 58 are configured to transmit at a single common wavelength, for example in the color blue. Alternatively, micro-LEDs 58 are configured to transmit in a plurality of other wavelengths, corresponding for example to the colors red, green, and blue.

A photo-diode array 60 is also fixedly mounted on back side 54, in proximity to array 50. Photo-diode array 60 comprises a plurality of photo-diodes 64, and the array has the same number of photo-diodes as there are micro-LEDs 58 in array 50. A lens cap 66B, comprising a plurality of micro-lenses aligned with photo-diodes 64, covers array 60. As is described below, photo-diodes 64 are used by device 22A to receive data, conveyed by light signals.

In a disclosed embodiment there are 400 micro-LEDs 58 in micro-LED array 50 and 400 photo-diodes in photo-diode array 60. Other embodiments may have any suitable larger or smaller quantity of micro-LEDs and photo-diodes than 400, and the actual number may be determined by one having ordinary skill in the art according to the characteristics of the data being transmitted and engineering constraints on the size of micro-LED array 50 and photo-diode array 60.

Array 50 and array 60 may be fixedly mounted on back side 54 by any suitable method. To implement the fixed mounting, micro-LED array 50 has surface mounted pads 68, that are connected to corresponding conductors 72 in back side 54, and photo-diode array 60 has surface mounted pads 76 that are connected to corresponding conductors 80 in the back side.

In a disclosed embodiment the connection is implemented by forming conductors 72 and 80 in back side 54 as conductive pillars, for example of copper or gold. The pillars are surrounded by insulating material, for example silicon dioxide. The connection to the surface mounted pads of the arrays may then be implemented by hybrid bonding the pads with the connectors, which fuses the pads with the connectors.

In some embodiments, to allow formation of the conductive pillars the thickness of die 38 may be reduced typically by etching and/or grinding, to be approximately 50 μm. The stability of such a thinned die may enhanced by attaching reinforcing structures to back side 54. In one embodiment, as illustrated, a conductive die attach film 84 is used to retain a reinforcing plate 88, and the plate may be formed from metal and/or glass and/or a semiconductor wafer such as silicon. To improve the thermal conductivity of plate 88, a plurality of thermally conductive vias 96, or other suitable heat pipes, may be incorporated into the plate, thereby enhancing thermal energy transfer from ASIC 14A when it is operational. Thermally conductive vias 96 may also be incorporated into back side 54, to further enhance the thermal energy transfer.

Once the surface mounted pads of the arrays have been connected to their respective conductors in back side 54, they may be used for powering the arrays and for conveying the data transmitted and received by the arrays. Conductive channels 98 and vias 100 are formed in die 38 and are configured to support power transfer to the arrays. Channels 98 and vias 100 also support data transfer from photo-diode array 60 to ASIC 14A, and data transfer from the ASIC to micro-LED array 50.

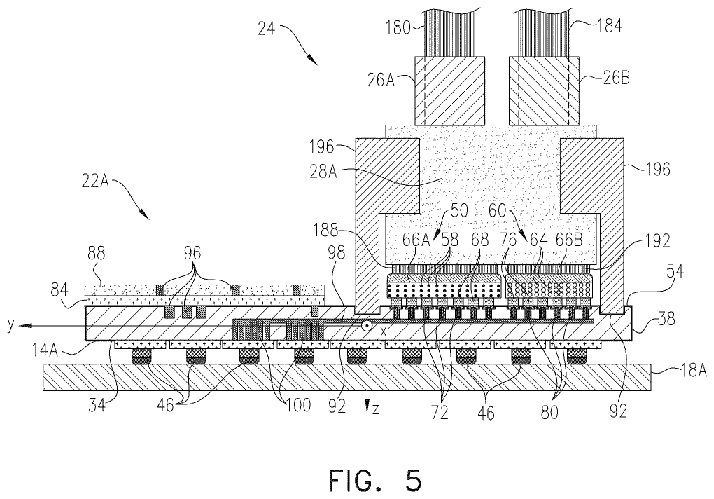

Alignment channels 92 are formed, typically by etching, in back side 54 and the channels are formed at pre-designed distances from array 50 and array 60. Channels 92 are used to facilitate the coupling of optic fiber bundles to array 50 and array 60, as is described below with reference to FIG. 5.

In an alternative embodiment, not shown in the figures, rather than channels being formed in back side 54, protrusions are formed therein. Protrusions may be formed, for example, by etching a pair of side-by-side channels in back side 54, the protrusions comprising the unetched section between the channels. As is the case with channels 92, protrusions may also facilitate the coupling and alignment of optic fiber bundles with array 50 and array 60. Using protrusions for coupling and alignment is described hereinbelow.

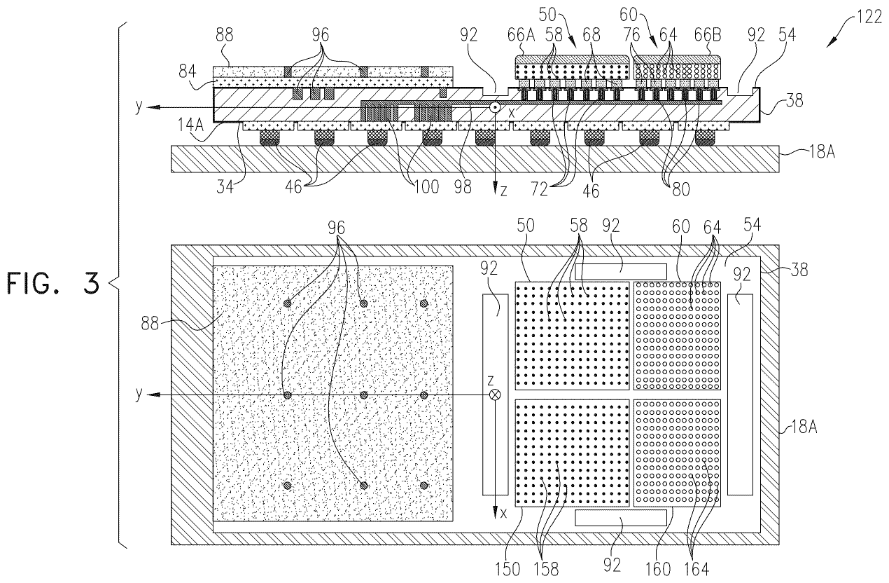

FIG. 3 is a schematic drawing of a side-view and a top-down view of an alternative communication device 122, according to an embodiment described herein. Except as described below, the operation of device 122 is generally similar to that of device 22A (FIGS. 1 and 2), and elements indicated by the same reference numerals in both devices 22A and 122 are generally similar in construction and in operation.

In contrast to device 22A which has one pair of micro-LED and photo-diode arrays, i.e., micro-LED array 50 and photo-diode array 60, device 122 comprises two pairs of arrays, i.e., a first pair: micro-LED array 50 and photo-diode array 60, and a second pair: a micro-LED array 150 and a photo-diode array 160. Micro-LED array 150 is similar in structure and operation to micro-LED array 50, having a plurality of micro-LEDs 158 that operate in a substantially similar manner as micro-LEDs 58. Photo-diode array 160 is similar in structure and operation to photo-diode array 60, having a plurality of photo-diodes 164 that operate similarly to photo-diodes 64. As for the first pair of micro-LED and photo-diode arrays, in the second pair of arrays described herein, i.e., array 158 and array 164, there are the same number of micro-LEDs and photo-diodes.

In some embodiments the numbers of micro-LEDs in the different micro-LED arrays are equal (and consequently the numbers of photo-diodes in the different photo-diode arrays are also equal). In some embodiments the numbers of micro-LEDs in the different micro-LED arrays are different (and consequently the numbers of photo-diodes in the different photo-diode arrays are also different).

The disclosure above describes communication devices having one and two pairs of micro-LED and photo-diode arrays. One having ordinary skill in the art will be able to adapt the disclosure, mutatis mutandis, for communication devices having more than two such pairs of arrays, so that the scope of the present disclosure comprises communication devices having any convenient number of such pairs.

As explained above with reference to FIG. 1, communication devices such as device 22A use an optical fiber cable pair to transmit and receive data. The following disclosure describes a process for coupling an optical fiber cable pair to a communication device.

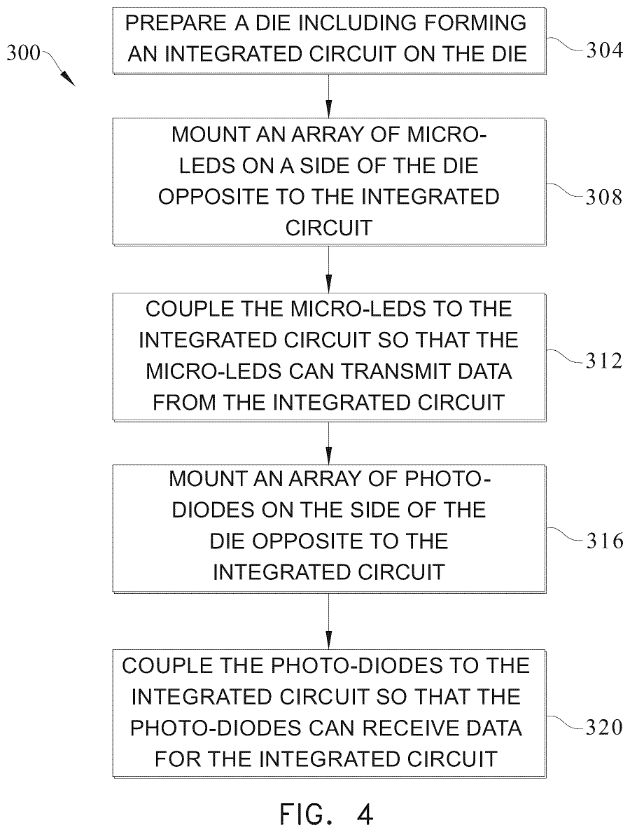

FIG. 4 is a flowchart 300 of steps for forming a communication device, according to an embodiment described herein.

For simplicity, the description of the flowchart uses, as an example, device 22A. Device 22A has a single pair of micro-LED and photo-diode arrays, and those having ordinary skill in the art will be able to adapt the description for forming communication devices having more than a single pair of micro-LED and photo-diode arrays.

In an initial step 304, an integrated circuit is formed on one side of a die, and the die is also prepared to accept the micro-LED and photo-diode arrays. In the example considered herein ASIC 14A is formed on active side 34 of die 38. In addition, conductors 72 and 80 are formed on back side 54, and channels 98 and vias 100 are also formed in the die. The implementation of step 304 may be by any method known in the art, such as by production in a fabrication facility.

In a micro-LED array mounting step 308, a micro-LED array is mounted on the side of die 38 opposite the active side. In the example herein, array 50 is mounted on conductors 72.

In a first coupling step 312, the micro-LEDs of the micro-LED array are configured to be able to transmit data from the integrated circuit. Thus, micro-LEDs 58 are configured to transmit data received from the integrated circuit, using channels 100 and vias 98.

In a photo-diode array mounting step 316, a photo-diode array is mounted on the side of die 38 opposite the active side. In the example herein, array 60 is mounted on conductors 80.

In a second coupling step 320, the photo-diodes of the photo-diode array are configured to be able to receive data for the integrated circuit. In the example herein, photo-diodes 64 are configured to received data for the integrated circuit, and then transmit the data to the integrated circuit, using channels 100 and vias 98.

FIG. 5 is a schematic diagram illustrating a method for coupling optical fiber cable pair 24 (illustrated in FIG. 1) to communication device 22A, according to an embodiment described herein. As is described above with reference to FIG. 1, cable pair 24 comprises optical fiber cable 26A and optical fiber cable 26B, and cable ending 28A of the cable pair is coupled to device 22A. Each optical fiber cable comprises at least one optical fiber bundle, the number of bundles being equal to the number of arrays connected to the cable, and each bundle is coupled with a respective array. Thus, in the case of device 22A where there is one micro-LED array 50 and one photo-diode array 60, optical fiber cable 26A has one optical fiber bundle 180 coupled to micro-LED array 50, and optical fiber cable 26B has one optical fiber bundle 184 coupled to photo-diode array 60.

(For communication device 122, which has two micro-LED arrays and two photo-diode arrays, each cable of the optical fiber cable pair connected to the device has two optical fiber bundles, each of the bundles coupling to a respective array of the device. It is noted that for devices having more than two micro-LED arrays and more than two photo-diode arrays the number of bundles in each cable scales accordingly.)

The ends of the fibers of optical fiber bundle 180 are secured in a bundle termination 188, and the ends of the fibers of optical fiber bundle 184 are secured in a bundle termination 192. Bundle terminations 188 and 192 are fixed within cable ending 28A, which acts as a housing for the bundle terminations, and which is also referred to herein as housing 28A.

Housing supports 196 are fixedly attached to housing 28A. The supports are configured to fit within channels 92 so that the ends of the fibers of bundle termination 188 align with, and are correctly distanced from, the micro-LEDs of array 50, and so that the ends of the fibers of bundle termination 192 align with, and are correctly distanced from, the photo-diodes of array 60.

The dimensions of channels 92 and housing supports 196 may be tightly controlled using suitable fabrication techniques such as etching. The very high precision of the dimension control facilitates the alignment described above, and also enables passive alignment, as is explained below.

In an embodiment, once supports 196 are fitted into channels 92, they are fixed to the channels so that during operation of device 22A the alignment described above is present. The fixation of the supports may be by cementing, with any suitable attachment material, ends of supports 196 into channels 92.

Note that any misalignment of arrays 50 and 60 with their respective bundle terminations reduces the operation efficiency of device 22A, and may even lead to the device ceasing to function.

In an alternative embodiment, housing supports 196 are removably attached to housing 28A and the supports may be fixed to channels 92 as described above. The removable attachment of housing 28A permits cable pair 24 to be disconnected from, and connected to, device 22A, so that when connected the alignment described above is present.

It is noted that by using channels 92 the alignment described above is passive, so there is no requirement for active alignment of the fibers of the optical fiber bundles with the arrays of device 22A. Active alignment typically requires measuring light intensities transmitted through one or more fibers of a bundle, and adjusting the alignment between the bundle and its coupled array to maximize the intensity. In passive alignment no such measurements or adjustments are required.

The disclosure above describes a procedure for how the fibers of cable pair 24 passively align with the elements of one pair of micro-LED and photo-diode arrays, as in device 22A. Those having ordinary skill in the art will be able to adapt the description, mutatis mutandis, to implement passive alignment for communication devices having more than one pair of micro-LED and photo-diode arrays, such as device 122, and all such passive alignment procedures are assumed to be comprised within the scope of the present disclosure.

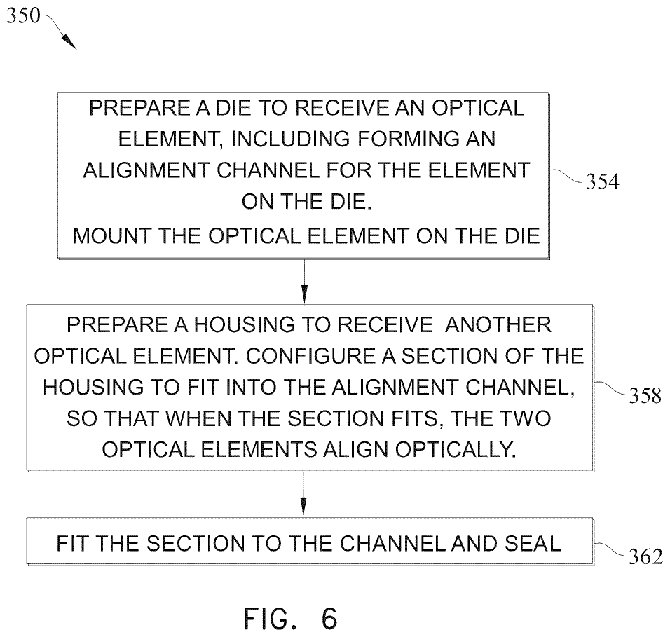

FIG. 6 is a flowchart 350 of steps for coupling two optical elements so that they align, according to an embodiment described herein. The flowchart description uses, by way of example, the alignment system described in FIG. 5 above, i.e., aligning arrays 50 and 6o of device 22A with optical fiber bundles. The description also includes producing the device.

In an initial step 354 a die is prepared to receive a first optical element, and at least one alignment channel is formed in the die, in proximity to the location of the optical element. In the example herein the optical element comprises arrays 50 and 60, the at least one channel comprises channels 92, and the arrays are mounted on the die, substantially as described above with reference to FIG. 2.

In a housing step 358 a housing is prepared to receive a second optical element, and a section of the housing is configured to fit into the at least one alignment channel so that when the section fits, the two optical elements align optically. In the example herein the section comprises housing supports 196, and the second optical element comprises bundle terminations 188 and 192.

In a completion step 362, the section is fit into the at least one alignment channel, and is then sealed to the at least one alignment channel, so as to complete the alignment procedure and the production of device 22A.

The description of alignment above, referring to FIG. 5 and FIG. 6, assumes that channels 92 are formed in back side 54, and that housing supports 196 fit within channels 92. In an alternative embodiment the channels may be formed in the housing supports. Protrusions, rather than channels, may be formed in back side 54, as is described above, and the protrusions may be configured to fit to the channels of the housing supports, so that when fit the arrays align with the bundle terminations.

Those having ordinary skill in the art will be able to adapt the description of FIG. 5 and FIG. 6, mutatis mutandis, to comprise the alternative embodiment using protrusions in back side 54.

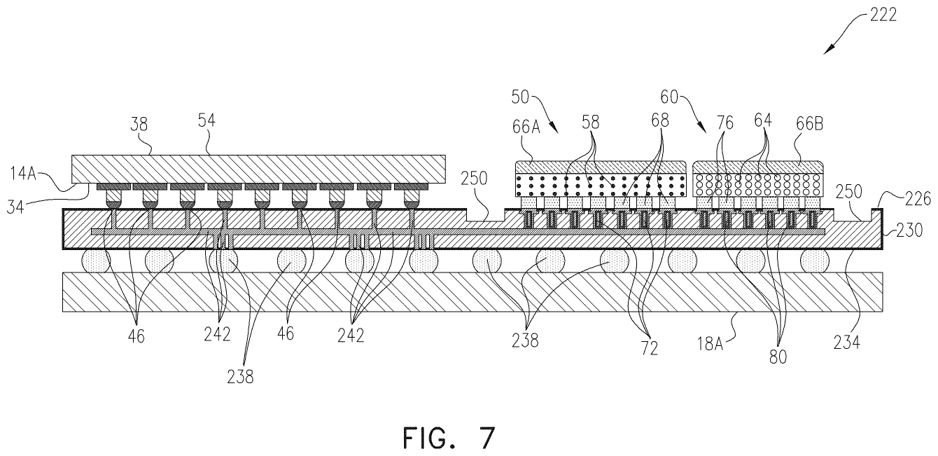

FIG. 7 is a schematic drawing of a side-view of a further alternative communication device 222, according to an embodiment described herein. Except as described below, the operation of device 222 is generally similar to that of device 22A (FIG. 2), and elements indicated by the same reference numerals in both devices 22A and 222 are generally similar in construction and in operation.

As is the case in device 22A, in device 222 ASIC 14A is formed on the active side 34 of semiconductor die 38. However, in contrast to device 22A, in device 222 micro-LED array 50 and photo-diode array 60 are not mounted on back side 54 of die 38, but are mounted on a first, upper, side 226 of a semiconducting interposer 230, typically formed from silicon. In addition, die 38 is mounted on interposer 230, so that surface mounted terminals 46 of ASIC 14A couple to upper side 226. A second, lower, side 234 of interposer 230 is coupled to substrate 18A by surface mounted terminals 238 attached to the interposer and to the substrate.

Interposer 230 comprises conductive channels 242 connecting arrays 50 and 60 to ASIC 14A via terminals 46, and connecting the arrays and ASIC 14A to substrate 18A via terminals 238. Channels 242 may be configured to power arrays 50 and 60, and ASIC 14A, as well as to transfer data signals between the arrays, the ASIC, and the substrate, substantially as described above for channels 98 and vias 100 of device 22A.

In some embodiments alignment channels 250 are formed in upper side 226, typically by etching, or other suitable high precision channel fabrication technique, at pre-designed distances from arrays 50 and 60. Channels 250 are substantially similar to alignment channels 92 and serve the same function as alignment channels 92, i.e., facilitating passive alignment of the ends of the fiber bundles of a cable pair with arrays 50 and 60, as described above with reference to FIGS. 5 and 6.

The description of device 222 assumes that the device has one micro-LED array 50 and one photo-diode array 60. Those having ordinary skill in the art will be able to adapt the description, mutatis mutandis, for communication devices having more than one micro-LED array and more than one photo-diode array, e.g., comparable to device 122, so that the scope of the present disclosure comprises communication devices using an interposer with more than one micro-LED array and more than one photo-diode array.

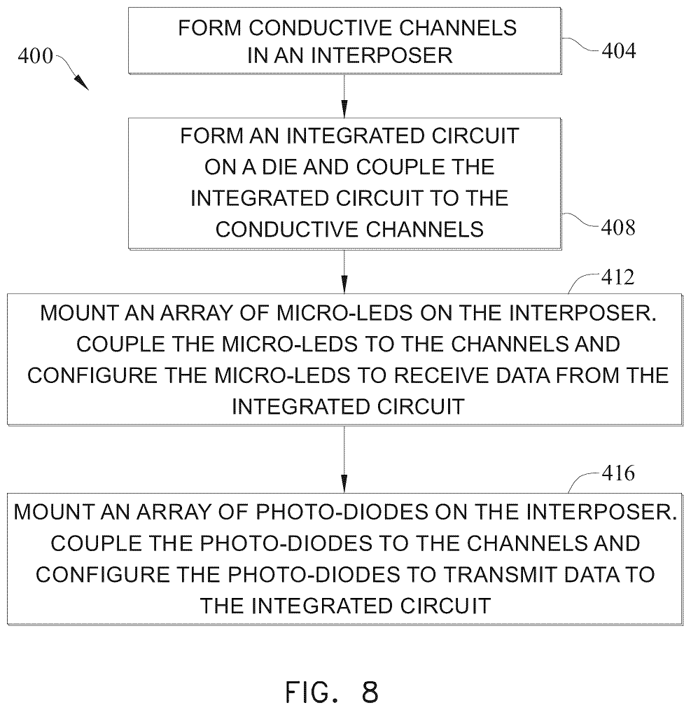

FIG. 8 is a flowchart 400 of steps for producing a communication device using an interposer, according to an embodiment described herein. For simplicity, the description of the steps of the flowchart uses, by way of example, the elements of device 222, and those having ordinary skill in the art will be able to adapt the description for other communication devices using in interposer.

In an initial step 404 a semiconducting interposer is implemented with a plurality of conductive channels. In the example herein, the interposer is interposer 230 with conductive channels 242.

In an integrated circuit step 408, an integrated circuit is formed on a die, herein die 38, and is coupled to the conductive channels of the interposer.

In a micro-LED step 412, an array, herein array 50, of micro-LEDs is mounted on the interposer, substantially as described above for interposer 230. The micro-LEDs of the array are coupled to the channels of the interposer and are configured to receive data from the integrated circuit.

In a photo-diode step 416, an array, herein array 60, of photo-diodes is mounted on the interposer, substantially as described above for interposer 230. The photo-diodes of the array are coupled to the channels of the interposer and are configured to transmit data to the integrated circuit.

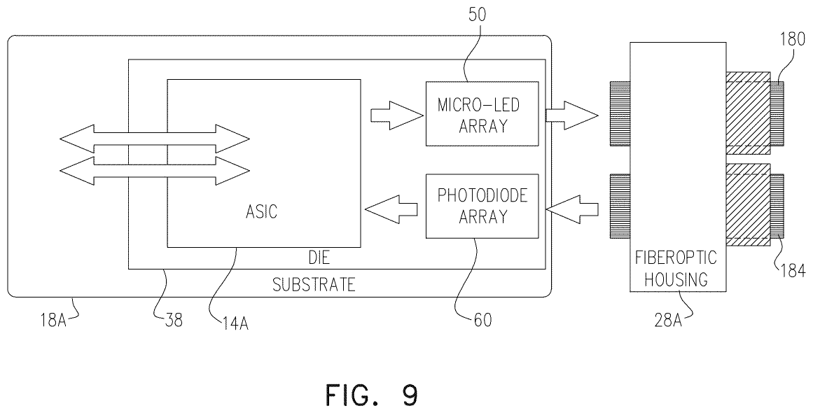

FIG. 9 is a schematic block diagram illustrating the data flow through communication devices described herein, according to an embodiment described herein. The diagram has been drawn using the elements of device 22A, and may be adapted, mutatis mutandis, for the other communication devices described herein.

As illustrated by the pair of double-headed arrows, data, in a substantially parallel format, transfers between ASIC 14A and substrate 18A. Data in a parallel format may also be generated within ASIC 14A.

Outgoing data from ASIC 14A transfers, in a substantially serial format as illustrated by the single-headed arrow, from the ASIC to micro-LED array 50, and from there to the plurality of fibers in optical fiber bundle 180. Incoming data to ASIC 14A is received by photo-diode array 60, in a substantially serial format, from the plurality of fibers in optical fiber bundle 184. The data, in a serial format, transfers from the photo-diode array to ASIC 14A.

It is noted that communication devices described herein may incorporate redundancy in operation of the devices. Typically, when a micro-LED array in a first communication device is connected, as described above, by an optical fiber bundle to a photo-diode array in a second communication device, not all the fibers of the bundle are used, because corresponding micro-LEDs and photo-diodes are not activated. If one of the operative fibers fails, because of a break in the fiber, or because of the micro-LED or the photo-diode failing, one of the unused fibers may be activated to replace the failed fiber.

It is noted that the embodiments described above are cited by way of example, and that the present disclosure is not limited to what has been particularly shown and described hereinabove. Rather, the scope of the present disclosure includes both combinations and subcombinations of the various features described hereinabove, as well as variations and modifications thereof which would occur to persons skilled in the art upon reading the foregoing description and which are not disclosed in the prior art.

1. A communication device, comprising:
at least one semiconducting die;
an electronic integrated circuit (EIC) formed on a first side of the at least one die;
at least one first array of micro-light emitting diodes (micro-LEDs), mounted on a second side of the at least one die that is opposite the first side, the micro-LEDs being electrically connected to the EIC and configured to transmit outbound optical signals to respective first optical fibers; and
at least one second array of photo-diodes, mounted on the second side of the at least one die, the photo-diodes being electrically connected to the EIC and configured to receive inbound optical signals from respective second optical fibers.

2. The communication device according to claim 1, further comprising:
an optical element, retained in a housing, configured to couple the first optical fibers to the at least one first array of micro-LEDs, and to couple the second optical fibers to the at least one second array of photo-diodes; and
at least one channel formed in the second side of the at least one die;
wherein a section of the housing is configured to fit into the at least one channel and thereby align the optical element with the at least one first array of micro-LEDs and the at least one second array of photo-diodes.

3. The communication device according to claim 2, wherein the at least one channel is formed at a pre-designed distance from the at least one first array of micro-LEDs and the at least one second array of photo-diodes.

4. The communication device according to claim 2, wherein the at least one first array of micro-LEDs comprises n first arrays, and the at least one second array of photo-diodes comprises n second arrays, wherein n is a positive integer, wherein the first optical fibers comprise n first optical fiber bundles that align with the n first arrays, and wherein the second optical fibers comprise n second optical fiber bundles that align with the n second arrays.

5. The communication device according to claim 1, further comprising conductive channels formed in the at least one die, and wherein the EIC, the at least one first array of micro-LEDs, and the at least one second array of photo-diodes are connected to the conductive channels and are configured to communicate therebetween via the conductive channels.

6. The communication device according to claim 1, wherein a quantity of micro-LEDs defining the at least one first array of micro-LEDs is equal to the quantity of photo-diodes defining the least one second array of photo-diodes.

7. The communication device according to claim 1, wherein the EIC is configured to convert outgoing data from the EIC from a parallel format to a serial format, and to provide the outgoing data in the serial format to micro-LEDs in the at least one first array of micro-LEDs.

8. The communication device according to claim 1, wherein the EIC is configured to receive incoming data to the EIC in a serial format from photo-diodes in the at least one second array of photo-diodes, and convert the incoming data from the serial format to a parallel format.

9. The communication device according to claim 1, wherein the at least one semiconducting die comprises a single die.

10. The communication device according to claim 1, wherein the at least one semiconducting die comprises a stack of dies.

11. The communication device according to claim 1, further comprising:
an optical element, retained in a housing, configured to couple the first optical fibers to the at least one first array of micro-LEDs, and to couple the second optical fibers to the at least one second array of photo-diodes; and
a protrusion formed in the second side of the at least one die;
wherein a section of the housing comprises a channel formed therein and that is configured to fit into the protrusion and thereby align the optical element with the at least one first array of micro-LEDs and the at least one second array of photo-diodes, and wherein the protrusion and the channel are formed by etching.

12. A method for aligning optical elements, comprising:
mounting a first optical element on a surface of a semiconducting die;
forming at least one channel in the surface of the die in proximity to the first optical element;
mounting a second optical element in a housing; and
configuring a section of the housing to fit into the at least one channel, so that when the section of the housing is fit into the at least one channel the first optical element aligns optically with the second optical element.

13. The method according to claim 12, wherein the first optical element comprises at least one first array of micro-light emitting diodes (micro-LEDs) and at least one second array of photo-diodes, and wherein the second optical element comprises first optical fibers configured to couple with the at least one first array of micro-LEDs and second optical fibers configured to couple with the at least one second array of photo-diodes.

14. The method according to claim 13, comprising forming the at least one channel at a pre-designed distance from the at least one first array of micro-LEDs and the at least one second array of photo-diodes.

15. The method according to claim 13, wherein the at least one first array of micro-LEDs comprises n first arrays, and the at least one second array of photo-diodes comprises n second arrays, wherein n is a positive integer, wherein the first optical fibers comprise n first optical fiber bundles that align with the n first arrays, and wherein the second optical fibers comprise n second optical fiber bundles that align with the n second arrays.

16. A communication device, comprising:
an interposer, comprising a plurality of conductive channels;
an electronic integrated circuit (EIC), formed on at least one die, coupled to the conductive channels;
at least one first array of micro-light emitting diodes (micro-LEDs) mounted on the interposer, the at least one first array of micro-LEDs being coupled to the conductive channels and configured to receive data from the EIC via the conductive channels; and
at least one second array of photo-diodes mounted on the interposer, the at least one second array of photo-diodes being coupled to the conductive channels and configured to transfer data to the EIC via the conductive channels.

17. The communication device according to claim 16, wherein the interposer comprises a first side and a second side opposite the first side, wherein the at least one die and the at least one first array of micro-LEDs and the at least one second array of photo-diodes are mounted on the first side.

18. The communication device according to claim 17, comprising a plurality of surface mounted terminals mounted on the second side, the surface mounted terminals being connected to the conductive channels and configured to transfer signals between the surface mounted terminals and the at least one first array of micro-LEDs, the at least one second array of photo-diodes, and the EIC.

19. The communication device according to claim 16, wherein the at least one first array of micro-LEDs is configured to transmit outbound optical signals to first optical fibers and the at least one second array of photo-diodes is configured to receive inbound optical signals from second optical fibers.

20. The communication device according to claim 19, further comprising:
an optical element, retained in a housing, configured to couple the first optical fibers to the at least one first array of micro-LEDs, and to couple the second optical fibers to the at least one second array of photo-diodes; and
at least one channel formed in a side of the interposer;
wherein a section of the housing is configured to fit into the at least one channel and thereby align the optical element with the at least one first array of micro-LEDs and the at least one second array of photo-diodes.

21. The communication device according to claim 20, wherein the at least one channel is formed at a pre-designed distance from the at least one first array of micro-LEDs and the at least one second array of photo-diodes.

22. The communication device according to claim 20, wherein the at least one first array of micro-LEDs comprises n first arrays, and the at least one second array of photo-diodes comprises n second arrays, wherein n is a positive integer, wherein the first optical fibers comprise n first optical fiber bundles that align with the n first arrays, and wherein the second optical fibers comprise n second optical fiber bundles that align with the n second arrays.
